(19) United States
(12) Patent Application Publication
(10) Pub. No.: US 2017/0046013 A1
(43) Pub. Date: Feb. 16, 2017

(54) WEB-BROWSER BASED DESKTOP AND APPLICATION REMOTING SOLUTION

(71) Applicant: Microsoft Technology Licensing, LLC, Redmond, WA (US)

(72) Inventors: Raymond Matthew Reskusich, Seattle, WA (US); Jayashree Sadagopan, Bellevue, WA (US); Lihua Zhu, Sunnyvale, CA (US); Sridhar Sankuratri, Sunnyvale, CA (US); Shir Aharon, Mountain View, CA (US); Jeroen Eduard van Eesteren, Palo Alto, CA (US); Greg Sun, Sunnyvale, CA (US); Derrick Isoka, San Mateo, CA (US); Munindra Nath Das, Redmond, WA (US); Travis Michael Howe, Seattle, WA (US); B. Anil Kumar, Saratoga, CA (US)

(21) Appl. No.: 14/827,229

(22) Filed: Aug. 14, 2015

(51) Int. Cl. G06F 3/0481; H04L 29/06

(52) U.S. Cl. CPC G06F 3/0481; H04L 65/403; H04L 67/42

(57) ABSTRACT

An invention is disclosed for conducting a remote presentation session with a client that uses a web browser to conduct the session. The client previously received browser-native program code that executes within a runtime environment of the web browser. The browser-native program code instantiates a remote presentation client executing within a runtime environment of the web browser. The server generates graphics encoded according to a remote presentation protocol and sends them to the remote presentation client for display in the web browser. The client captures user input at the web browser and sends it to the remote presentation client, which encodes it with the remote presentation protocol and sends it to the server to be processed.

### BACKGROUND

In a remote presentation session, a client computer and a server computer communicate across a communications network. The client sends the server locally-received input, such as mouse cursor movements and keyboard presses. In turn, the server receives this input and performs processing associated with it, such as executing an application in a user session. When the server performs processing that results in output, such as graphical output or sound, the server sends this output to the client for presentation. In this manner, applications appear to a user of the client to execute locally on the client when they, in fact, execute on the server.

A problem with conventional remote presentation sessions is that the client participating in the remote presentation session needs to have installed upon it a remote presentation session application—an application that is configured to communicate with the server in accordance with the remote presentation session protocol. This requirement means that there may be many computers accessible to a user that have a network connection that may communicate with the remote presentation session server, but lack the remote presentation session application with which to conduct a remote presentation session.

There are also techniques for a client to conduct a remote presentation session with a web browser, rather than a remote-presentation-session-specific application. In these techniques, commonly the remoted desktop image is subdivided into a plurality of tiles, and each of these image tiles are sent to the client (or an indication of the tile, where the client has cached the tile), and displayed in the client's web browser. When the remoted desktop image changes, the “dirty” tiles are determined—those tiles where the image has changed—and those dirty tiles are sent to the client for display via the web browser.

There are many problems with these techniques for a client conducting a remote presentation session using a web browser, some of which are well known.

### SUMMARY

One problem with a client conducting a remote presentation session using a web browser where the client displays image tiles is a problem of performance. Compared to a remote presentation session using a specific remote presentation session application, the web browser-and-image-tiles techniques offer a much lower frame rate. Not only is the frame rate much lower, but frequently the frame rate is so low that it negatively impacts user experience. That is, the frame rate is often so low that motions displayed in the remote presentation session are jerky, and there is a disconnect between the input the user provides and when the user sees the graphical result of processing that input.

It would therefore be an improvement to provide an invention for a client lacking a remote presentation session application to conduct a remote presentation session with a server using video rather than image tiles. In embodiments of the invention, a client has a web browser application that is configured to both display video and receive user input that is directed to the web browser application. The client may use the web browser to establish an AJAX (Asynchronous JavaScript and XML—Extensible Markup Language) connection with the server to open a connection. The client and server then exchange information to authenticate the client to the server.

The client then captures user input (e.g. mouse, keyboard, or touch) directed to the web browser window and asynchronously sends it to the server. The server receives this input and injects it into the appropriate application or user session. As an application or user session generates graphical output, the server captures this graphical output, encodes it to video, and sends it to the client for display via the web browser.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 depicts an example general purpose computing environment in which embodiments of the invention may be implemented.

FIG. 2 depicts an example operational environment for implementing aspects of the present invention.

FIG. 3 depicts a client conducting a remote presentation session with a web browser, where, a remote session client executing within the web browser converts remote presentation session data into video.

FIG. 4 depicts two frames of graphical data to be encoded as video, where a portion of each frame contains the same image, though in a different location, and where one frame may be encoded based on an encoding of the other frame.

FIG. 5 depicts a frame of graphical data to be encoded as video, where the frame shares common features with a previous frame, and has “dirty” regions where the frames are different.

FIG. 6 depicts an embodiment of a method for a server conducting a remote presentation session as a remote session host, with a client that uses a web browser as a remote session client.

FIG. 7 depicts an embodiment of a method for a server conducting a remote presentation session as a remote session host, with a client that uses a web browser as a remote session client.

FIG. 8 depicts an example virtual machine server that may be host one or more virtual machines that conduct a remote presentation session with a client, the client using a web browser and receiving remote presentation graphics as video.

FIG. 9 depicts another example virtual machine server that may be host one or more virtual machines that conduct a remote presentation session with a client, the client using a web browser and receiving remote presentation graphics as video.

FIG. 10 depicts an example system comprising a virtual machine server that hosts a plurality of virtual machines, each virtual machine conducting a remote presentation session with a client, the client using a web browser and receiving remote presentation graphics as video.

### DETAILED DESCRIPTION OF ILLUSTRATIVE EMBODIMENTS

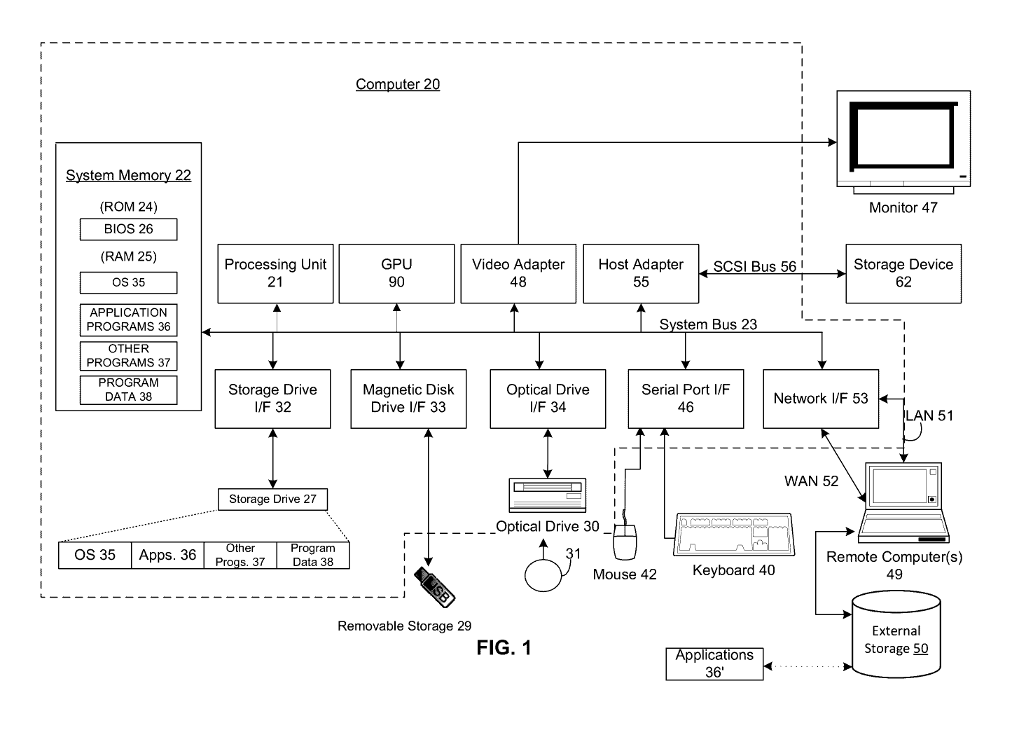

Embodiments of the invention may execute on one or more computer systems. FIG. 1 and the following discussion are intended to provide a brief general description of a suitable computing environment in which embodiments of the invention may be implemented.

The term circuitry used throughout can include hardware components such as hardware interrupt controllers, hard drives, network adaptors, graphics processors, hardware based video/audio codecs, and the firmware used to operate such hardware. The term circuitry can also include microprocessors, application specific integrated circuits, and processors, e.g., cores of a multi-core general processing unit that perform the reading and executing of instructions, configured by firmware and/or software. Processor(s) can be configured by instructions loaded from memory, e.g., RAM, ROM, firmware, and/or mass storage, embodying logic operable to configure the processor to perform a function(s).

In an example embodiment, where circuitry includes a combination of hardware and software, an implementer may write source code embodying logic that is subsequently compiled into machine readable code that can be executed by hardware. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary computing system 100 is depicted. Computer system 20 can include processor 21, e.g., an execution core. While one processor 21 is illustrated, in other embodiments computer system 20 may have multiple processors, e.g., multiple execution cores per processor substrate and/or multiple processor substrates that could each have multiple execution cores. As shown by the figure, various computer-readable storage media can be interconnected by one or more system busses which couples various system components to the processor 21. The system buses may be any of several types of bus structures including a memory bus or memory controller, a peripheral bus, and a local bus using any of a variety of bus architectures. In example embodiments the computer-readable storage media can include for example, random access memory (RAM) 25, storage device 27, e.g., electromechanical hard drive, solid state hard drive, etc., firmware, e.g., FLASH RAM or ROM, and removable storage devices such as, for example, CD-ROMs 31, floppy disks 29, DVDs, FLASH drives, external storage devices, etc. It should be appreciated by those skilled in the art that other types of computer readable storage media can be used such as magnetic cassettes, flash memory cards, and/or digital video disks.

Computer-readable storage media can provide non volatile and volatile storage of processor executable instructions, data structures, program modules and other data for the computer system 20 such as executable instructions. A basic input/output system (BIOS) 26, containing the basic routines that help to transfer information between elements within the computer system 20, such as during start up, can be stored in system memory 22. A number of programs may be stored on firmware, storage device 27, RAM 25, and/or removable storage devices 29, and executed by processor 21 including an operating system and/or application programs. Generally, such computer-readable storage media can be used in some embodiments to store processor executable instructions tangibly embodying aspects of the present disclosure.

Commands and information may be received by computer system 20 through input devices which can include, but are not limited to, a keyboard 40 and pointing device 42. Other input devices may include a microphone, joystick, game pad, scanner or the like. These and other input devices are often connected to processor 21 through a serial port interface that is coupled to the system bus, but may be connected by other interfaces, such as a parallel port, game port, or universal serial bus (USB). A display or other type of display device can also be connected to the system bus via an interface, such as a video adapter which can be part of, or connected to, a graphics processor unit 90. In addition to the display, computers typically include other peripheral output devices, such as speakers and printers (not shown). The exemplary system of FIG. 1 can also include a host adapter, Small Computer System Interface (SCSI) bus, and an external storage device connected to the SCSI bus.

Computer system 20 may operate in a networked environment using logical connections to one or more remote computers, such as a remote computer. The remote computer may be another computer, a server, a router, a network PC, a peer device or other common network node, and typically can include many or all of the elements described above relative to computer system 20. When used in a LAN or WAN networking environment, computer system 20 can be connected to the LAN or WAN through network interface card (NIC) 53. NIC 53, which may be internal or external, can be connected to the system bus. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

In a networked environment, program modules depicted relative to computer system 100, or portions thereof, may be stored in a remote memory storage device accessible via NIC 53. It will be appreciated that the network connections shown are exemplary and other means of establishing a communications link between the computers may be used. In an embodiment where computer system 20 is configured to operate in a networked environment, the operating system is stored remotely on a network, and computer system 20 may netboot this remotely-stored operating system rather than booting from a locally-stored operating system. In an embodiment, computer system 100 comprises a thin client having an operating system that is less than a full operating system, but rather a kernel that is configured to handle networking and display output.

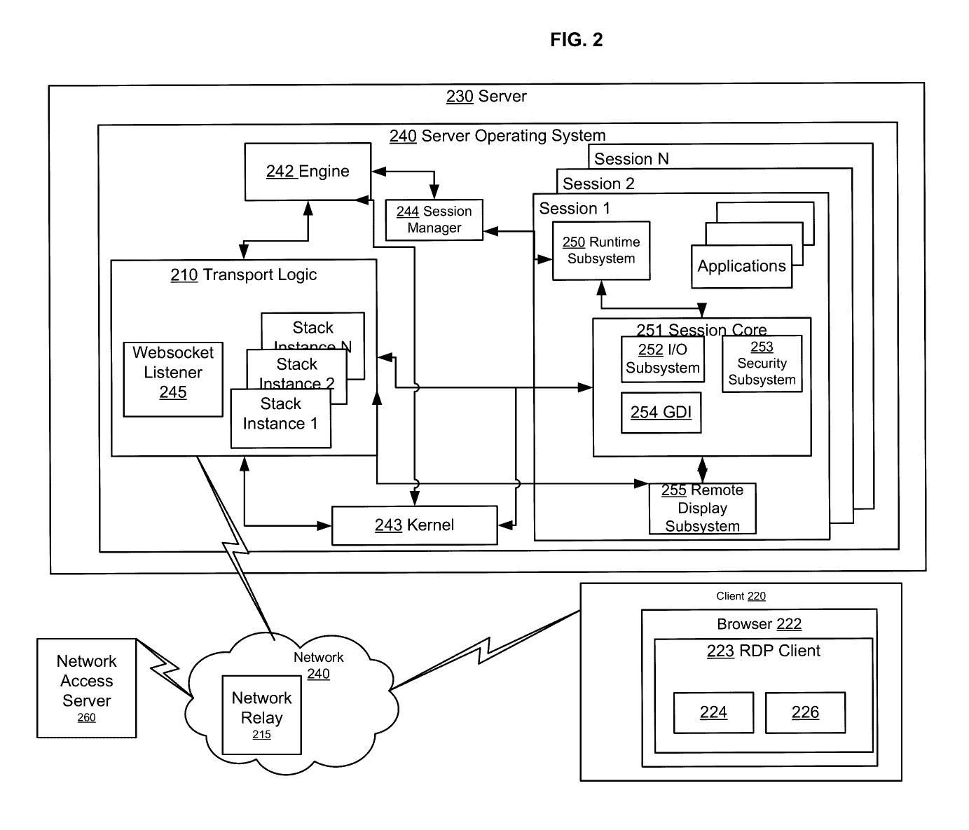

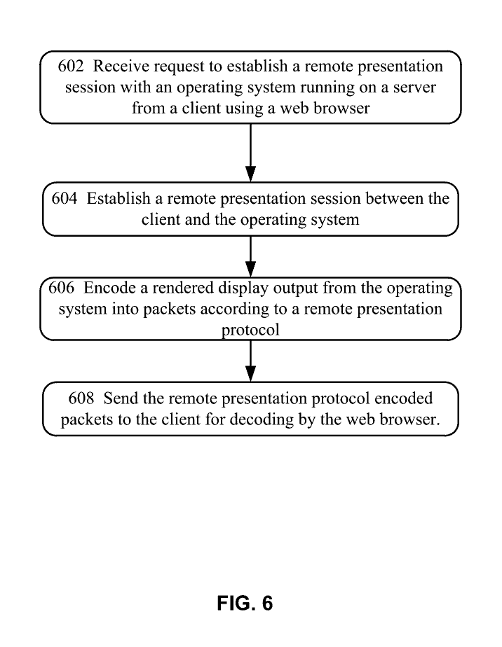

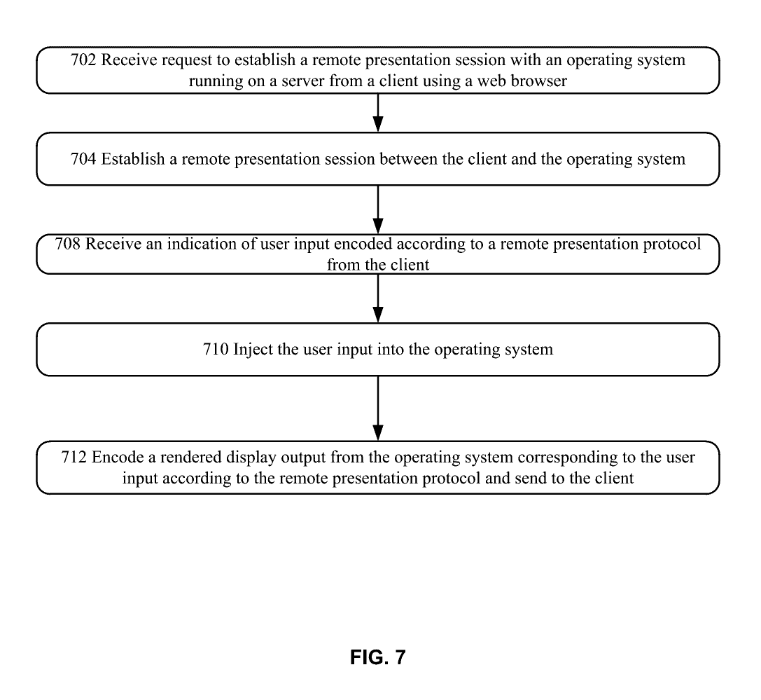

FIG. 2 depicts an example operational environment 200 for implementing aspects of the present invention. For instance, server 230 may implement the methods 600 and 700 of FIGS. 6 and 7, respectively. One skilled in the art can appreciate that the example elements depicted by FIG. 2 are illustrated to provide an operational framework for describing the present invention. Accordingly, in some embodiments the physical layout of each environment may be different depending on different implementation schemes. Thus, the example operational framework is to be treated as illustrative only and in no way limit the scope of the claims.

Operational environment 200 includes client 220 that is comprised of circuitry configured to effectuate REMOTE DESKTOP PROTOCOL (RDP) client 223 executing within a runtime environment of a web browser or other web based interface (browser 222). In an embodiment, client 220 may be implemented in computing device 20 of FIG. 1. A user, in operational environment 200, interacts with client 220 to connect to a remote desktop or application session (remote session) hosted on server 230 over network 210. In an embodiment, a remote session is an operating system running on server 230. Briefly, a remote session in example embodiments of the present invention can generally include an operational environment that is effectuated by a plurality of subsystems, e.g., software code, that are configured to interact with kernel 243 of server 230. For example, a remote session can include a process that instantiates a user interface such as a desktop window representing a graphical output created by the remote session, subsystems that track mouse movement within the window, subsystems that translate a mouse click on an icon into commands that effectuate an instance of a program, etc. Such graphical output created by a remote session is described herein as “graphical user interface (GUI) data”. In an embodiment, GUI data is a rendered display output from an operating system running on server 230. As described herein, a computing device includes a processor and a memory, and may also comprise virtualization components permitting a plurality of computing devices to share underlying physical hardware.

In an embodiment, client 220 may connect to remote sessions hosted on server 230 via remote access server 260 by exchanging remote session data encoded according to an RDP protocol (RDP-encoded data). For example, client 220 may establish a hypertext transport protocol (HTTP) connection with remote access server 260 using browser 222. Through the HTTP connection, remote access server 260 provides client 220 with browser-native program code (e.g. Javascript) that browser 222 executes to instantiate RDP client 223, in this example. In an embodiment, RDP client 223 is a native RDP client executing within browser 222. RDP client 223 includes socket client 224 that establishes a socket connection with a socket host. In an embodiment, the socket host is implemented as a network relay (e.g. WebSocket relay 215). In an embodiment, the socket host is implemented as a socket listener in transport logic 241, such as WebSocket listener 745. While the remote session data exchanged between server 230 and client 220 is described herein as being encoded according to an RDP protocol, those skilled in the art will recognize that the remote session data (e.g. a rendered display output from an operating system running on server 230) may be encoded according to any known remote presentation session protocol without departing from the spirit of the present invention.

Once connected to the session, the user may interact with the remote session by providing commands and other information (user input) to client 220 through input devices similar to input devices 116 of FIG. 1. Client 220 encodes the user input into RDP-encoded user input using RDP and transmits the RDP-encoded user input to server 230 that hosts the remote session using a NIC similar to NIC 53 of FIG. 1. In an embodiment, client 220 may encode the user input with RDP codec 226. Server 230 decodes the RDP-encoded user input upon receipt and injects the user input into the remote session. The remote session generates GUI data, which server 230 encodes into RDP-encoded GUI data for transmission to client 220. Upon receipt, RDP client 223 executing within browser 222, decodes the RDP-encoded GUI data using the browser-native program code that browser 222 executes within its native runtime environment). In an embodiment, RDP client 223 forwards the decoded RDP-encoded GUI data to browser 222's native decoding capabilities to display the GUI data. For example, RDP client 223 may forward the decoded RDP-encoded GUI data to browser 222's native decoding capabilities through a “video” tag. In an embodiment, RDP client 223 translates the decoded RDP-encoded GUI data into and forwards to browser 222 a series of browser-native graphics operations. For example, RDP client 223 may forward to browser 222 one or more “canvas” tags. As such, client 220 represents any device capable of receiving user input, transmitting the user input to a remote computing device hosting a remote session, and displaying graphical data associated with the remote session received from the remote computing device.

As appreciated by one skilled in the art, because RDP client 223 is executed within the application framework of web browser 222, RDP client 223 is allowed access to only those system resources (e.g., CPU time, memory, etc.) that are accessible to web browser 222. web page when download and loaded/displayed in a browser (causing execution of the modules) provides several features of the invention described below. In addition, RDP client 223 is instantiated in web browser through browser-native program code (e.g. Javascript) comprising an HTML file. Accordingly, aspects of the present invention may be implemented without installing a plug-ins to web browser 222 or an RDP-specific application to client 220.

Operational environment 200 also includes server 230, which is comprised of circuitry configured to effectuate a remote presentation session server. In an embodiment, server 230 can further include circuitry configured to support remote desktop connections. In the example depicted by FIG. 2, server 230 generates one or more remote sessions for connecting clients such as remote sessions 1 through N (where N is an integer greater than 2). A remote session can be generated by server 230 on a user by user basis by server 230 when, for example, server 230 receives a remote presentation session connection request over a network connection (e.g. network 210) from a client, such as client 220. Generally, a remote presentation session connection request can first be handled by transport logic 241 that can, for example, be effectuated by circuitry of server 230. Transport logic 241 can in some embodiments include a network adaptor; firmware, and software that can be configured to receive connection messages and forward them to engine 242. As illustrated by FIG. 2, transport logic 241 can in some embodiments include protocol stack instances for each session. Generally, each protocol stack instance can be configured to route user interface output to a client and route user input received from the client to the session core 251 associated with its session.

Continuing with the general description of FIG. 2, engine 242 in some example embodiments of the present invention can be configured to process requests for sessions; determine the functionality for each session; generate sessions by allocating a set of physical resources for the session; and instantiating a protocol stack instance for the session. In some embodiments engine 242 can be effectuated by specialized circuitry components that can implement some of the above mentioned operational procedures. For example, the circuitry in some example embodiments can include memory and a processor that is configured to execute code that effectuates engine 242.

In some instances, engine 242 can receive remote presentation session connection requests and determine that, for example, a license is available and a session can be generated for the request. In the situation where server 230 is a remote computer that includes remote desktop capabilities, engine 242 can be configured to generate a session in response to a remote presentation session connection request without checking for a license. As illustrated by FIG. 2, a session manager 244 can be configured to receive a message from engine 242 and in response to the message, session manager 244 can: add a session identifier to a table; assign memory to the session identifier; and generate system environment variables and instances of subsystem processes in memory assigned to the session identifier.

As illustrated by FIG. 2, session manager 244 can instantiate environment subsystems such as a runtime subsystem 250 that can include a kernel mode part such as the session core 251. For example, the environment subsystems in an embodiment are configured to expose some subset of services to application programs and provide an access point to kernel 243 of operating system 240. In example embodiments, the runtime subsystem 250 can control the execution of processes and threads and the session core 251 can send requests to the executive of the kernel 243 to allocate memory for the threads and schedule time for them to be executed. In an embodiment, the session core 251 can include a graphics display interface 254 (GDI), a security subsystem 253, and an input subsystem 252. The input subsystem 252 can in these embodiments be configured to receive user input from client 220 via the protocol stack instance associated with the session and transmit the input to the session core 251 for the appropriate session. The user input can in some embodiments include signals indicative of absolute and/or relative mouse movement commands, mouse coordinates, mouse clicks, keyboard signals, joystick movement signals, etc. User input, for example, a mouse double-click on an icon, can be received by the session core 251 and the input subsystem 252 can be configured to determine that an icon is located at the coordinates associated with the double-click. The input subsystem 252 can then be configured to send a notification to the runtime subsystem 255 that can execute a process for the application associated with the icon.

In addition to receiving input from a client 220, draw commands can be received from applications and/or a desktop and be processed by the GDI 254. The GDI 254 in general can include a process that can generate graphical object draw commands. The GDI 254 in this example embodiment can be configured to pass its output to the remote display subsystem 255 where the commands are formatted for the display driver that is attached to the session. In certain example embodiments one or more physical displays can be attached to the server 230, e.g., in a remote desktop situation. In these example embodiments the remote display subsystem 255 can be configured to mirror the draw commands that are rendered by the display driver(s) of the remote computer system and transmit the mirrored information to the client 220 via a stack instance associated with the session.

In another example embodiment, where the server 230 is a remote presentation session server, the remote display subsystem 255 can be configured to include virtual display driver(s) that may not be associated with displays physically attacked to server 230, e.g., server 230 could be running headless. The remote display subsystem 255 in this embodiment can be configured to receive draw commands for one or more virtual displays and transmit them to client 220 via a stack instance associated with the session. In an embodiment of the present invention, the remote display subsystem 255 can be configured to determine the display resolution for each display driver, e.g., determine the display resolution of the virtual display driver(s) associated with virtual displays or the display resolution of the display drivers associated with physical displays; and route the packets to client 220 via the associated protocol stack instance.

In some example embodiments the session manager 244 can additionally instantiate an instance of a logon process associated with the session identifier of the session that can be configured to handle logon and logoff for the session. In these example embodiments drawing commands indicative of the graphical user interface associated with the logon process can be transmitted to the client 220 where a user of the client 220 can input an account identifier, e.g., a username/password combination, a smart card identifier, and/or biometric information into a logon screen. The information can be transmitted to server 230 and routed to engine 242 and the security subsystem 253 of the session core 251. For example, in certain example embodiment, engine 242 can be configured to determine whether the user account is associated with a license; and the security subsystem 253 can be configured to generate a security token for the session.

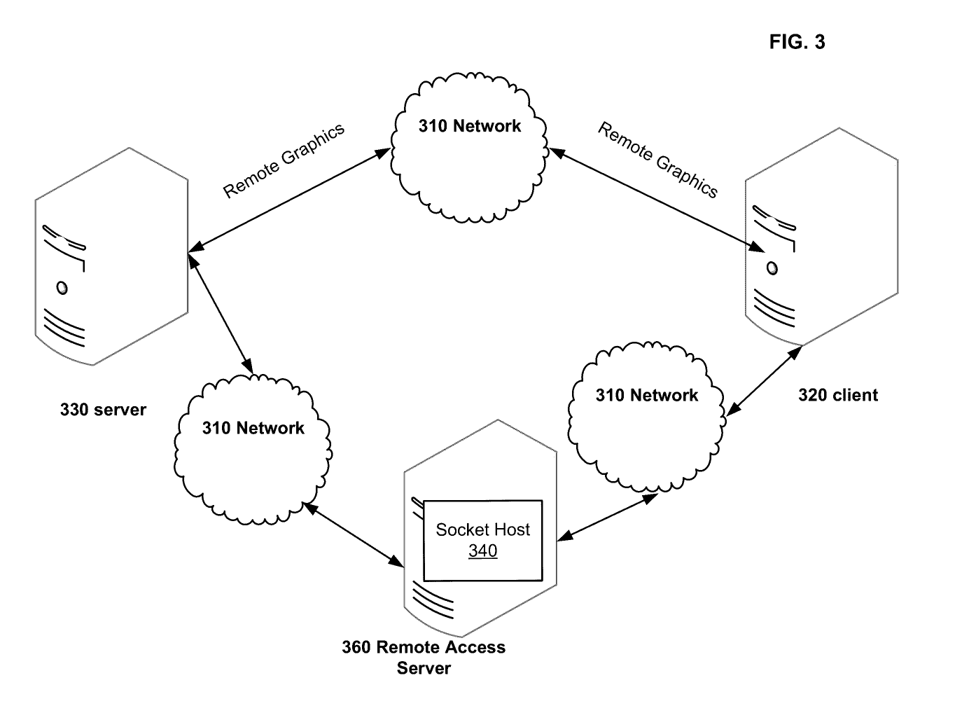

FIG. 3 depicts a client conducting a remote presentation session with a web browser, where a server generates video from graphical output created by an instance of an application or desktop that is being remoted. In embodiments, server 330 may be implemented in server 230 of FIG. 2 and client 320 may be implemented in client 220 of FIG. 2. In embodiments, server 330 is conducting a remote session with client 320 by exchanging RDP-encoded data with a RDP client 325 running in a web browser executing on client 320. In an embodiment, RDP client 325 is instantiated by the web browser executing browser-native program code within a native runtime environment of the web browser. In an embodiment, the browser-native program code is downloaded by client 320 from a network resource that is accessible to client 320 via network 310. In an embodiment, the network resource includes servers other than server 330 that is conducting the remote session with client 320.

Client 320 may initiate a remote presentation session by submitting a connection request to establish the remote session over an HTTP connection with a remote access server 360 providing access to server 330 via network 310. One skilled in the art will recognize that remote access server 360 and server 330 may be operating on the same physical hardware. The HTTP connection may be a variation of HTTP, such as a HTTPS (HTTP Secure) connection. In an embodiment, establishing an HTTP connection is effectuated by a user of client 320 providing user input for a web browser of client 320 to open a web page associated with remote access server 360. For example, the user may enter a uniform resource locator (URL) into an address field of web browser that directs the web browser to a web page usable by the user to access the remote presentation session. In an embodiment, the URL is a network address associated with a login web page. The HTTP connection may be an AJAX connection between client 320 and remote access server 360.

In response to the connection request, remote access server 360 may send a connection response to client 320 comprising an HTML file for the web page associated with remote access server 360. In an embodiment, client 320 may tangibly store the connection response in a computer-readable storage device accessible by the web browser. In an embodiment, remote access server 360 provides client 320 with browser-native program code by embedding the browser-native program code within the HTML file. Alternatively, remote access server 360 provides client 320 with browser-native program code by including instructions (e.g. embedded links) in the HTML file that directs the browser of client 320 to a network storage location (not shown) where the browser-native program code may be downloaded.

When executed within a runtime environment of client 320's browser, the browser-native program code may implement an RDP client 325 executing within application framework associated with the browser. Once implemented, RDP client 325 may establish a first socket connection between RDP client 325 and socket host 340 using a native socket API of the browser of client 320. In an embodiment, to establish a first socket connection, RDP client 325 may send a socket handshake request via a native socket API of client 320's browser to the socket host 340. Upon receiving the socket handshake request, socket host 340 may send a socket handshake response to RDP client 325 via a native socket API of client 320's browser.

Similarly, socket host 340 establishes a second socket connection with server 330 upon establishing the first socket channel. The first and second socket channels, collectively, establish a socket transport channel between RDP client 325 and server 330 using the HTTP connection as a conduit. In an embodiment, socket host 340 is implemented within a network relay intervening between client 320 and server 330 within network 310 (e.g. network relay 215 of FIG. 2). In an embodiment, socket host 340 is implemented as a socket listener within the transport logic of server 330 (e.g. socket listener 245 of FIG. 2). The socket transport channel enables full-duplex, asynchronous communication between RDP client 325 and server 330. In an embodiment, one or more of the first socket channel and the second channel may be implemented using an HTML5 compliant WebSocket API. In an embodiment, communications between RDP client 325 and server 330 can take place over a secure transport, such as, by way of example and not limitation, utilizing Transport Layer Security (TLS) or Secure Sockets Layer (SSL).

Client 320 may establish a remote presentation session with server 330, using RDP client 325, via the socket transport channel. In this remote presentation session, client 320 serves as the remote session client (such as client 220 of FIG. 2) using RDP client 325, and server 330 serves as the remote session host server (such as server 230 of FIG. 2). In embodiments, when server 330 establishes a remote presentation session with client 320, server 330 uses an indication of a login associated with the session to determine a session or application to remote in the remote presentation session. For example, there may be a disconnected session associated with the login that the server 330 reconnects, or no session at all (in which case server 330 may instantiate a new session for the login). Where the session output of an application is remoted rather than the graphical output of a session (which may include one or more applications), the same process may occur—reconnecting a disconnected application, or initiating an application where there is no disconnected application.

In an embodiment, this login may comprise client 320 authenticating itself to remote access server 360 (which, in turn, may use a credential associated with the authentication to authenticate to server 330). This authentication may, for instance, comprise client 320 sending a user identification and password to remote access server 360, which remote access server 360 may authenticate against a database of user-password pairs. In an embodiment, remote access server 360 does not authenticate client 320 itself, but, rather, forwards a credential from client 320 to server 330.

Server 330 may then transmit the graphical output of what is being remoted (e.g. GUI data) to client 320 via the remote presentation session as RDP-encoded GUI data. This may be performed in a manner similar to how server 230 of FIG. 2 remotes GUI data to client 220. Server 330 transmits the RDP-encoded GUI data to client 320 by sending the RDP-encoded GUI data comprised of a plurality of remote presentation protocol packets to socket host 340. Socket host 340 transmits the RDP-encoded GUI data to RDP client 325 over the socket transport channel. The RDP-encoded GUI data is prepared for transmission over the socket transport channel by encapsulating each of the remote presentation protocol packets—otherwise unaltered—into socket frames. As appreciated by one skilled in the art, no middle-ware APIs are needed to implement the various aspects of the present invention since RDP client 325 executing within a runtime environment of client 320's web browser receives the RDP-encoded GUI data as transmitted by server 330.

RDP client 325 receives the encapsulated RDP-encoded GUI data and de-encapsulates the otherwise unaltered RDP-encoded GUI data using the browser-native program code that executes within the browser's native runtime environment). RDP client 325 decodes the RDP-encoded GUI data and forwards the decoded RDP-encoded data to the browser of client 320, as discussed above with respect to RDP client 223 of FIG. 2. For example, client's browser may be configured to process data in HTML5 format, including natively decoding one or more video formats referenced by a HTML5<video>tag. Client 320 decodes the video and displays it in the browser. In certain embodiments, the RDP client 325 decodes the RDP-encoded GUI data to produce GUI data in a format that the browser of client 320 can display directly. In embodiments when the GPU (Graphics Processing Unit) is present on the Client, the RDP client can use WebGL APIs to offload some of the decode process of the RDP-encoded GUI data to the GPU on the client. In embodiments when the GPU (Graphics Processing Unit) is present on the Client, the RDP client can use WebGL APIs to offload some of the decode process of the RDP-encoded GUI data to the GPU on the client.

Client 320 may issue commands that affect what server 330 processes. A user of client 320 may provide input directed to the browser of client 320. This input may comprise input such as mouse, keyboard, and touch input, along with an indication of where the input was made relative to the video (e.g. 50 pixels to the right and 50 pixels below the upper left corner of the displayed video). Client 320 may capture this input at the browser using JavaScript techniques for detecting input. Client 320 may then send the input to RDP client 325.

RDP client 325 receives the input from client 320 and encodes the input as RDP-encoded input data. RDP client 325 may then send this RDP-encoded input data to server 330, via socket host 340, where server 330 injects the input into the appropriate application or user session for the remote presentation session, and performs processing associated with input being provided to that application or user session. When that processing results in the generation of additional GUI data, server 330 may encode this additional GUI data and send it to RDP client 325 executing within the browser of client 320, which converts it to video for client 320 to display.

In embodiments, server 330 and remote access server 360 may be executed on virtual machines (VMs), both virtual machines executing on the same physical host computer. In such a scenario, server 330 and remote access server 360 may communicate via a loopback connection (one that uses an IP address that refers to the network interface that it uses itself—such as 127.0.0.1). Server 330 may listen on port 3389 and remote access server 360 may listen on port 3390, for example. Then, server 330 may communicate with remote access server 360 by transmitting data to 127.0.0.1:3390, and remote access server 360 may communicate with server 330 by transmitting data to 127.0.0.1:3389.

Using a loopback connection between the server 330 and remote access server 360 executing on the same physical machine allows a legacy remote presentation server to operate without modification. This is similar to how using remote access server 360 as an intermediary between server 330 and a client that uses a web browser to conduct a remote presentation session allows a legacy server to operate without modification. With regard to the loopback connection, a legacy remote presentation server that is configured only to transmit data to a client across a communications network interface may be used to effectuate embodiments of the invention, because the server will still communicate with a client (or the proxy) across a network communications interface.

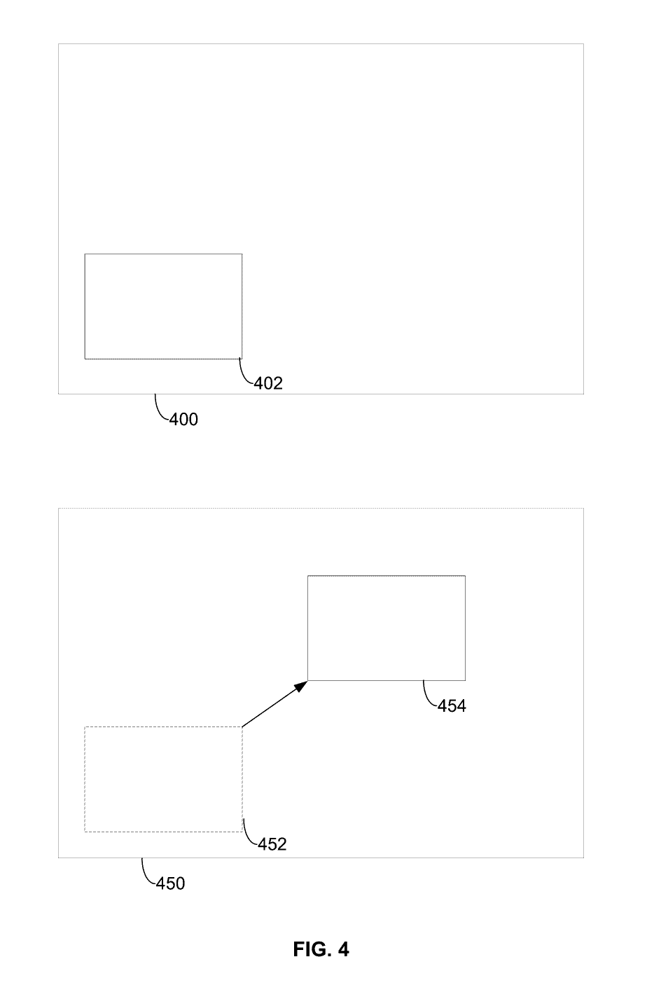

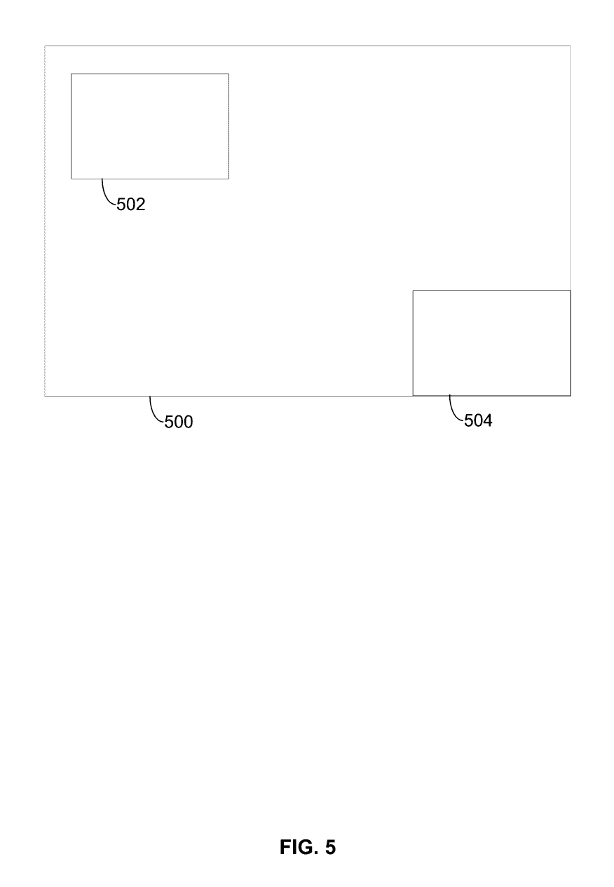

FIGS. 4 and 5 depict techniques for encoding graphics data as video to be transmitted in a remote presentation session. Where server 330 is encoding the GUI data for multiple remote sessions as video, server 330's processing capabilities may quickly become taxed or strained. In view of this, embodiments of the invention provide efficient ways to encode the GUI data of a remote session as video. Some of these embodiments are depicted in FIGS. 4 and 5.

FIG. 4 depicts two frames of GUI data to be encoded as video, where a portion of each frame contains the same image, though in a different location, and where one frame may be encoded based on an encoding of the other frame. Frame 400 is a frame of GUI data from a computer desktop, and frame 450 is a frame of frame of GUI data depicting that same desktop at a later time. Frame 400 comprises portion 402. In frame 450, that portion 402 of frame 400 has been moved from location 452 to location 454. Therefore, portions 402 and 454 depict the same image, just in a different location. Thus, the portion 454 of frame 450 may not need to be re-encoded. Rather, frame 450 excluding portion 454 may be encoded and then combined with the previously encoded portion 402 (placed in encoded frame in the location of portion 454) to produce an encoded frame 450. In using previously encoded frame of GUI data to encode frame 450, the computing resources necessary to encode frame 450 may be reduced, allowing a server or proxy that is encoding the frame to concurrently encode more frames (and thus, concurrently conduct more remote presentation sessions) than it would otherwise be able to concurrently encode.

FIG. 5 depicts a frame of frame of GUI data to be encoded as video, where the frame shares common features with a previous frame, and has “dirty” regions where the frames are different. Frame 500 contains two dirty regions—dirty regions 502 and 504—where frame 500 differs from a frame that preceded it and which has been encoded. Frame 500 may be encoded as video by encoding dirty regions 502 and 5704 and then combining these encoded dirty regions with the previously encoded non-dirty regions taken from the encoding of the previous frame. Like with respect to FIG. 4, in using previously encoded frame of GUI data to encode frame 500, the computing resources necessary to encode frame 500 may be reduced, allowing a server that is encoding the frame to concurrently encode more frames (and thus, concurrently conduct more remote presentation sessions) than it would otherwise be able to concurrently encode.

FIG. 6 depicts an embodiment of method 600 for a server conducting a remote presentation session as a remote session host, with a client that uses a web browser as a remote session client. In embodiments, method 600 may be effectuated by server 330 of FIG. 3, as it conducts a remote session with client 320. It may be appreciated that, with respect to FIGS. 6 and 7, there are embodiments of the invention that do not implement all of the depicted operations, or that implement the depicted operations in a different order than is described herein. In step 602, the server receives a request to establish a remote presentation session with a remote presentation session process of the server from the client. In an embodiment, the remote presentation session process is an operating system running on the server. In an embodiment, the client has previously downloaded browser-native program code to the web browser, as discussed above with respect to RDP client 223 of FIG. 2. This may be effectuated, such as by the client sending a remote access server a HTTP request for data via a HTTP session. In an embodiment, the request for data may comprise a request for a web page associated with the remote access server. In an embodiment, the browser-native program code instantiates a RDP client executing within a runtime environment of the web browser. That is, the RDP client executes within an application framework associated with the web browser.

In step 604, the server establishes the remote presentation session between the client and the remote session (or operating system running on the server). In an embodiment, the server may authenticate a credential received from the client prior to establishing the remote presentation session with the RDP client. For example, the server may determine a HTTP session token that uniquely identifies the HTTP session and send it to the client. The client may store this token (such as in the form of an HTTP cookie) and then transmit it to the server in future communications to identify the HTTP session. In an embodiment, the credential is associated with a user authorized to conduct the remote presentation session with the remote presentation session process. In an embodiment, the server identifies the remote presentation session process based, in part, on the credential. In step 606, the server encodes the GUI data generated by the remote presentation session process into a plurality of packets according to a remote presentation protocol. In step 608, the server sends the plurality of packets to the client for decoding by the web browser using the browser-native program code to display the GUI data. In an embodiment, the plurality of packets encoded according to the remote presentation protocol is natively decoded and displayed within the web browser. In an embodiment, the client displays the GUI data as a video element embedded in a web page.

In embodiments, one or more steps of method 600 include encoding the graphical data as video based on having previously encoded a second graphical data as second video. That is, the current video being encoded may have commonalities with previously encoded video, and the server may exploit these commonalities to reduce the processing resources used to encode the GUI data as video. For instance, this may comprise encoding the GUI data based on a dirty region of the graphical data relative to the second graphical data, and using at least part of the second video to encode the graphical data. This may occur, for instance, as depicted with respect to frame 500 of FIG. 5. Where there are a few updates between the first GUI data and the second GUI data, these updates may be expressed as “dirty regions” that identify the areas of the respective GUI datas that differ. Then, the server may encode only the dirty regions of the GUI data as video, and combined these encoded dirty regions with the second video that contains video of the non-dirty regions to create video of the GUI data.

Embodiments of encoding the GUI data as video based on having previously encoded a second GUI data as second video also include encoding the GUI data based on an element depicted in the GUI data also being depicted in the second GUI data, the element being depicted in a different location in the GUI data than in the second GUI data, and using at least part of the second video to encode the GUI data. That is, an application window (or the like) may have been moved between the GUI data and the second GUI data. This may occur, for instance, as depicted with respect to frames 500 and 550 of FIG. 5. Where this move is identified, the server may take the portion of the second video corresponding to the application window and use it to create the video. It may encode as video those portions of the GUI data that are not that application window, and combine that with the encoded video of the application window from the second window.

In embodiments, one or more steps of method 600 include receiving an indication that a first part of the GUI data comprises text and a second part of the GUI data comprises an image or video; and encoding the GUI data as video based on the indication that the first part of the GUI data comprises text and the second part of the graphical data comprises the image or video. Some remote presentation servers are configured to receive “hints” from the applications whose graphical output they are remoting, where these hints indicate what the graphical output is—e.g. text, solid fills, images, or videos. Some remote presentation servers are configured to analyze graphical data to determine this information. In such embodiments, the video may be encoded based on this information. For example, users may be more sensitive to seeing compression artifacts in text than in images. The server may variably encode the graphical output to video, such that it uses a more lossy compression on the portions of the graphical output that are images than on the portions of the graphical output that are text.

FIG. 7 depicts an embodiment of method 700 for a server conducting a remote presentation session as a remote session host, with a client that uses a web browser as a remote session client. In step 702, the server receives a request to establish a remote presentation session with a remote presentation session process of the server from a web browser of the client. In an embodiment, the remote presentation session process is an operating system running on the server. In an embodiment, the client has previously downloaded browser-native program code to the web browser, as discussed above with respect to RDP client 223 of FIG. 2. In step 704, the server establishes the remote presentation session between the remote session and the client. In an embodiment, steps 702 and 704 are substantially similar to steps 602 and 604 of method 600, respectively. In step 706, the server receives an indication of user input directed to the web browser asynchronously from sending GUI data encoded with a remote presentation protocol to the RDP client. In an embodiment, the indication is received by the server as RDP-encoded user input, as described above with respect to FIG. 3. For example, as the client displays the video in the web browser, the user may provide input to the web browser, such as by moving a mouse cursor, or typing at a keyboard. This information may be captured by the client and sent to the server via the remote presentation session.

In step 708, the server injects the user input into the remote presentation session process. In step 710, the server sends a second GUI data encoded with the remote presentation protocol to the RDP client, the second graphical data corresponding to a graphical result of executing an operation associated with the user input on the server. For example, the server may have received the user input, performed processing associated with the user input, and generated more remote presentation session graphical data associated with a graphical result (as well as possibly an audio result, or perhaps only an audio result) from performing processing associated with the user input.

In an embodiment, the client in one or more of methods 600 and 700 may receive RDP-encoded GUI data in a format that is natively supported by the client's browser. In an embodiment, the RDP-encoded GUI data may include video data that may be displayed within a web page by the browser, such as by using the HTML5 <video> tag. In an embodiment, the client in one or more of methods 600 and 700 may extract video data from the RDP-encoded GUI data and provide it to an HTML5 <video> object using a scriptable interface (e.g. W3C Media Source Extensions). In an embodiment, the RDP-encoded GUI data may include video data that the browser may decode using the native capabilities of the browser rather than the browser-native program code downloaded by the client.

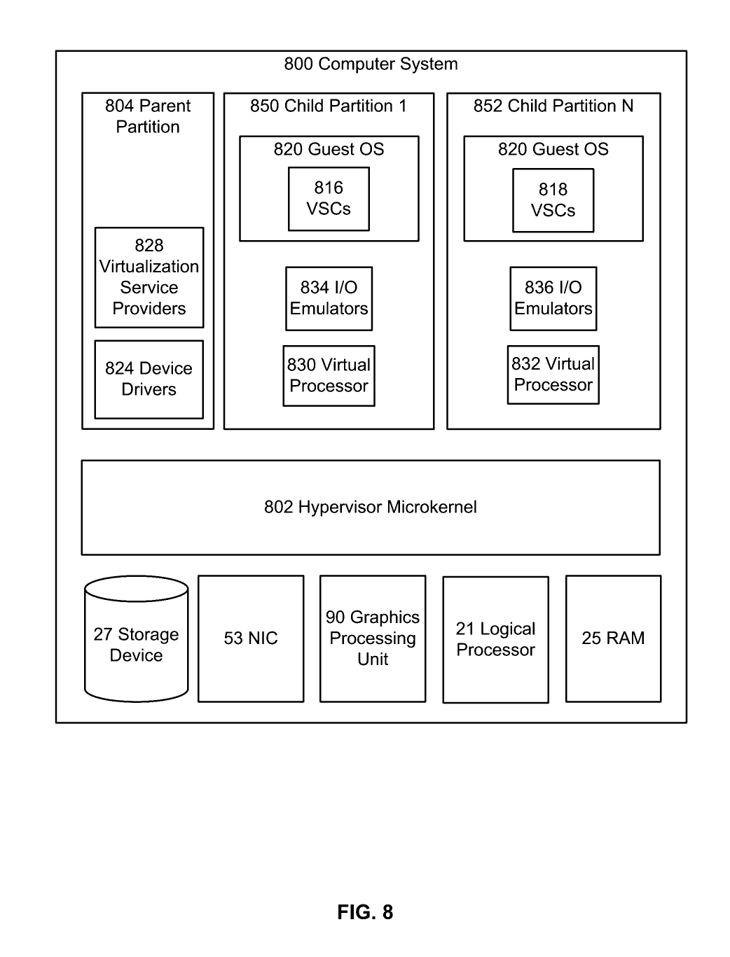

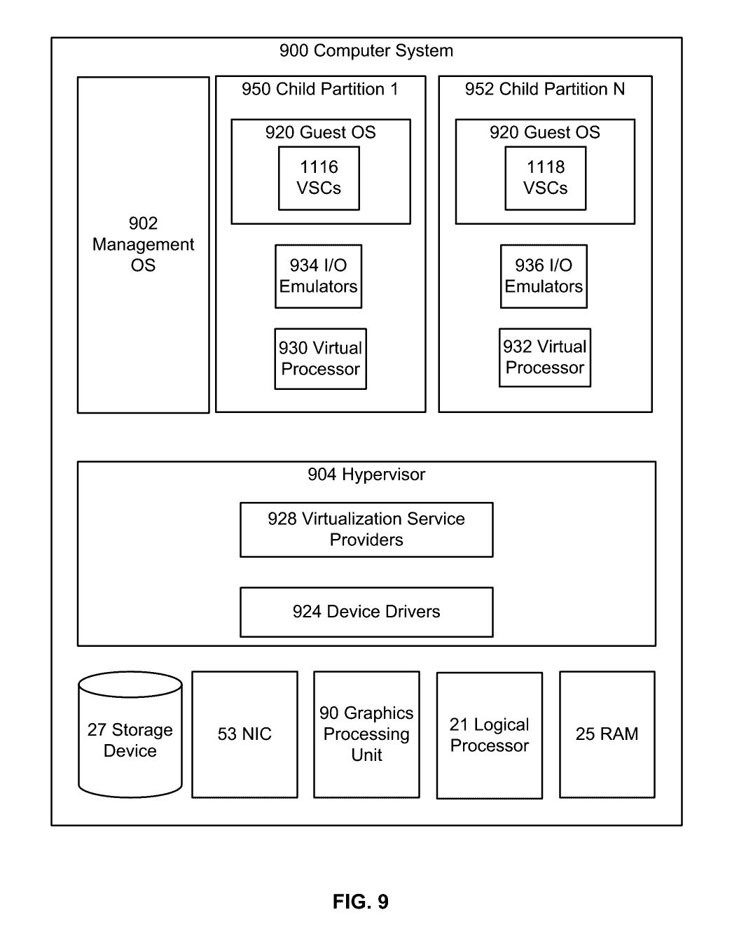

FIGS. 8 and 9 depict high level block diagrams of computer systems 800 and 900 configured to effectuate virtual machines. In example embodiments of the invention, computer systems 800 and 900 can include elements described in FIG. 1. As shown by the figures, different architectures can exist; however, they generally have similar components. For example, FIG. 8 illustrates an operational environment where a hypervisor, which may also be referred to in the art as a virtual machine monitor, is split into a microkernel 802 and a parent partition 804. FIG. 9 illustrates hypervisor 904 as including elements found in the parent partition 804 of FIG. 8.

FIG. 8 depicts an example virtual machine server that may be host one or more virtual machines that conduct a remote presentation session with a client, the client using a web browser and receiving remote presentation graphics as GUI data encoded with a remote presentation protocol. Hypervisor microkernel 802 can be configured to control and arbitrate access to the hardware of computer system 800. Broadly, hypervisor microkernel 802 can generate execution environments called partitions such as child partition 1 850 through child partition N 852 (where N is an integer greater than 1). In embodiments a child partition is the basic unit of isolation supported by hypervisor microkernel 802. That is, each child partition can be mapped to a set of hardware resources, e.g., memory, devices, logical processor cycles, etc., that is under control of the hypervisor microkernel 802 and hypervisor microkernel 802 can isolate processes in one partition from accessing another partition's resources, e.g., a guest operating system in one partition may be isolated from the memory of another partition and thus may not be able to detect memory addresses outside of its partition. In embodiments hypervisor microkernel 802 can be a stand-alone software product, a part of an operating system, embedded within firmware of the motherboard, specialized integrated circuits, or a combination thereof.

Parent partition 804 in this operational environment can be configured to provide resources to guest operating systems executing in the child partitions 1-N by using virtualization service providers 828 (VSPs) that are typically referred to as back-end drivers in the open source community. Broadly, VSPs 828 can be used to multiplex the interfaces to the hardware resources by way of virtualization service clients (VSCs) (typically referred to as front-end drivers in the open source community) and communicate with the virtualization service clients via communication protocols. As shown by the figures, virtualization service clients can execute within the context of guest operating systems. These drivers are different than the rest of the drivers in the guest in that they may be supplied with a hypervisor, not with a guest.

Microkernel 802 can enforce partitioning by restricting a guest operating system's view of system memory. Guest memory is a partition's view of memory that is controlled by a hypervisor. The guest physical address can be backed by system physical address (SPA), i.e., the memory of the physical computer system, managed by hypervisor. As shown by the figure, in an embodiment the GPAs and SPAs can be arranged into memory blocks, i.e., one or more pages of memory. When a guest writes to a block using its page table the data is actually stored in a block with a different system address according to the system wide page table used by hypervisor.

As shown by FIG. 8, in embodiments of the present disclosure IO emulators (834 and 836), e.g., virtualized IDE devices, virtualized video adaptors, virtualized NICs, etc., can be configured to run within their respective child partitions. Described in more detail below, by configuring the emulators to run within the child partitions the attack surface of the hypervisor is reduced as well as the computational overhead.

Each child partition can include one or more virtual processors (830 and 832) that guest operating systems (820 and 822) can manage and schedule threads to execute thereon. Generally, the virtual processors are executable instructions and associated state information that provide a representation of a physical processor with a specific architecture. For example, one virtual machine may have a virtual processor having characteristics of an INTEL x86 processor, whereas another virtual processor may have the characteristics of a PowerPC processor. The virtual processors in this example can be mapped to logical processors of the computer system such that the instructions that effectuate the virtual processors will be backed by logical processors. Thus, in an embodiment including multiple logical processors, virtual processors can be simultaneously executed by logical processors while, for example, other logical processor execute hypervisor instructions. The combination of virtual processors and memory in a partition can be considered a virtual machine.

Guest operating systems can include any operating system such as, for example, different versions of the MICROSOFT WINDOWS operating system (e.g. WINDOWS XP and WINDOWS 10). The guest operating systems can include user/kernel modes of operation and can have kernels that can include schedulers, memory managers, etc. Generally speaking, kernel mode can include an execution mode in a logical processor that grants access to at least privileged processor instructions. Each guest operating system can have associated file systems that can have applications stored thereon such as terminal servers, e-commerce servers, email servers, etc., and the guest operating systems themselves. The guest operating systems can schedule threads to execute on the virtual processors and instances of such applications can be effectuated.

FIG. 9 depicts another example virtual machine server that may be host one or more virtual machines that conduct a remote presentation session with a client, the client using a web browser and receiving remote presentation graphics as GUI data encoded with a remote presentation protocol. FIG. 9 depicts an alternative architecture to that described above in FIG. 8. FIG. 9 depicts similar components to those of FIG. 8; however in this example embodiment the hypervisor 904 can include the microkernel component and components from the parent partition 804 of FIG. 8 such as the virtualization service providers 828 and device drivers 824 while management operating system 902 may contain, for example, configuration utilities used to configure hypervisor 904. In this architecture hypervisor 904 can perform the same or similar functions as hypervisor microkernel 802 of FIG. 8; however, in this architecture hypervisor 904 can be configured to provide resources to guest operating systems executing in the child partitions. Hypervisor 904 of FIG. 9 can be a stand alone software product, a part of an operating system, embedded within firmware of the motherboard or a portion of hypervisor 904 can be effectuated by specialized integrated circuits.

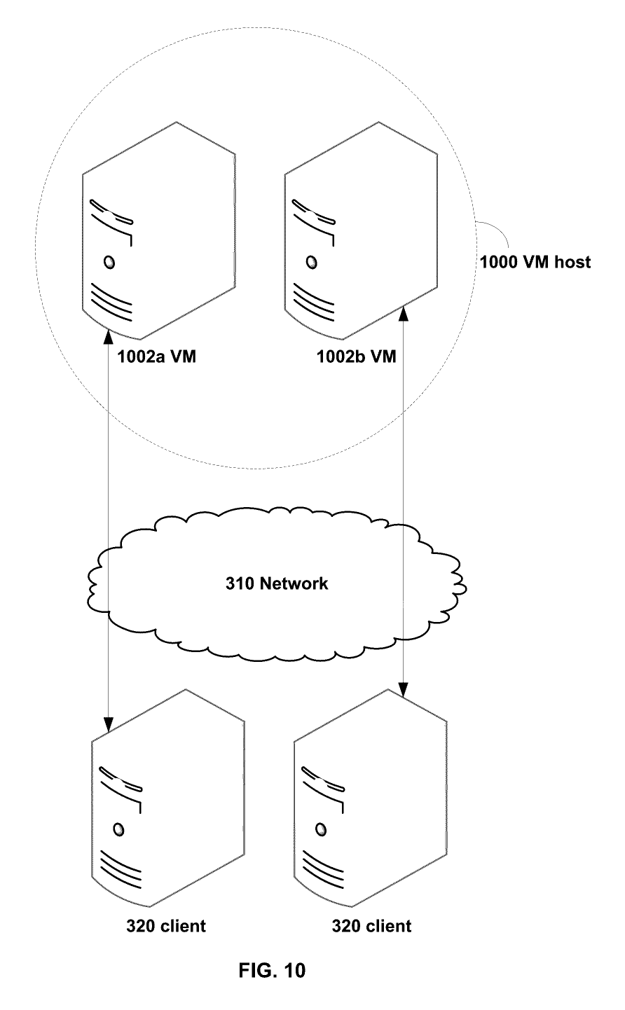

FIG. 10 depicts an example system comprising a virtual machine server that hosts a plurality of virtual machines, each virtual machine conducting a remote presentation session with a client, the client using a web browser and receiving remote presentation graphics as video. In embodiments, VM host 1000 may be embodied in computer system 800 of FIG. 8 or computer system 900 FIG. 9. In such embodiments, VM 1002a and VM 1002b may be embodied in child partitions 850 or 852 of FIGS. 8 and 9.

As depicted, VM 1002a and 1002b are each configured to serve remote presentation sessions with one or more clients that receive video via the remote presentation session, and conduct the remote presentation session via a web browser. For instance, each of VM 1002a and 1002b may be configured to effectuate the functions of server 320 of FIG. 3. In such embodiments, a client 320 may connect to VM host 1000, and VM host may direct one of its VMs to serve the remote presentation session with that client. VM host 1000 may make this direction, for example, based on balancing the load of each VM that it hosts.

The illustrations of the aspects described herein are intended to provide a general understanding of the structure of the various aspects. The illustrations are not intended to serve as a complete description of all of the elements and features of apparatus and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

It should be understood that the various techniques described herein may be implemented in connection with hardware or software or, where appropriate, with a combination of both. The subject matter presented herein may be implemented as a computer process, a computer-controlled apparatus or a computing system or an article of manufacture, such as a computer-readable storage medium.

The techniques, or certain aspects or portions thereof, may, for example, take the form of program code (i.e., instructions) embodied in tangible storage media or memory media implemented as storage devices, such as magnetic or optical media, volatile or non-volatile media, such as RAM (e.g., SDRAM, DDR SDRAM, RDRAM, SRAM, etc.), ROM, etc., that may be included in computing devices or accessible by computing devices. When the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

The previous description of the aspects is provided to enable a person skilled in the art to make or use the aspects. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed:

1. A method for conducting a remote presentation session with a client that uses a web browser, comprising:
receiving a request from the client to establish a remote presentation session with an operating system running on a server, wherein the client has previously downloaded browser-native program code;
establishing the remote presentation session between the client and the operating system;
encoding a rendered display output from the operating system into a plurality of packets according to a remote presentation protocol; and
sending the plurality of packets to the client for decoding by the web browser using the browser-native program code to display the rendered display output.

2. The method of claim 1, wherein the browser-native program code instantiates a remote presentation client that enables the web browser to function as a remote presentation session client.

3. The method of claim 1, wherein the client displays the rendered display output without a remote presentation session specific application running on the client.

4. The method of claim 1, wherein the browser-native program code instantiates a remote presentation client that executes within an application framework associated with the web browser.

5. The method of claim 1, wherein the browser-native program code instantiates a remote presentation client that enables the web browser to natively parse remote presentation protocol encoded data.

6. The method of claim 1, wherein the browser-native program code enables the web browser to natively decode the plurality of packets encoded according to the remote presentation protocol within a native runtime environment of the web browser.

7. The method of claim 1, further comprising:
prior to establishing the remote presentation session with the client, authenticating a credential received from the client, the credential being associated with a user authorized to conduct the remote presentation session with the operating system.

8. The method of claim 1, wherein the client previously downloaded the browser-native program code from a remote access server providing access to the server.

9. The method of claim 1, wherein the client previously downloaded browser-native program code that executes within a native runtime environment of the web browser to instantiate a remote presentation client.

10. A system comprising:
one or more computing devices that comprise a first set of instructions to be performed that at least:
process a request from a client to establish a remote presentation session with an operating system running on a server, wherein the client has previously downloaded browser-native program code;
establish the remote presentation session between the client and the operating system; and
process an indication of user input directed to the operating system from the client via a transport channel established between the client and a socket host, wherein the indication is encoded according to a remote presentation protocol by the web browser using the browser-native program code.

11. The system of claim 10, wherein the one or more computing devices further comprise a second set of instructions to be performed that at least:
upon processing the indication of user input, inject the indication of user input into the operating system by the server.

12. The system of claim 10, wherein the one or more computing devices further comprise a third set of instructions to be performed that at least:
encode a rendered display output from the operating system into a plurality of packets according to the remote presentation protocol, wherein the rendered display output corresponds to the operating system processing the user input.

13. The system of claim 10, wherein the transport channel is established between the client and the socket host using the browser-native program code.

14. The system of claim 10, wherein the socket host is implemented by a WebSocket relay intervening between the server and the client.

15. The system of claim 10, wherein the socket host is implemented as a WebSocket listener.

16. The system of claim 10, wherein the server is executing within a virtual machine.

17. A computer-readable storage device for conducting a remote presentation session with a client that uses a web browser, bearing computer-readable instructions that, when executed upon a computing device, cause the computing device to perform operations comprising:
processing a received request from the client to establish a remote presentation session with an operating system running on a server, wherein the client has previously downloaded browser-native program code;
establishing the remote presentation session between the client and the operating system;
encoding a rendered display output from the operating system into a plurality of packets according to a remote presentation protocol;
preparing the plurality of packets for sending to the client for decoding by the web browser using the browser-native program code to display the rendered display output; and
processing a received indication of user input directed to the operating system from the client in response to the rendered display output, wherein the indication is encoded according to the remote presentation protocol by the web browser using the browser-native program code.

18. The computer-readable storage device of claim 17, wherein the received indication from the client is received asynchronously from sending the plurality of packets to the client.

19. The computer-readable storage device of claim 17, further bearing computer-readable instructions that, when executed upon the computing device, cause the computing device to perform operations comprising:
encoding an updated rendered display output from the operating system into a plurality of updated packets according to the remote presentation protocol, the updated rendered display output corresponding to the operating system processing the user input; and
preparing the plurality of updated packets for sending to the client for decoding by the web browser using the browser-native program code to display the updated rendered display output.

20. The computer-readable storage medium of claim 19, wherein the updated rendered display output represents a sub-portion of the rendered display output.
